(19) United States
(12) Patent Application Publication
(10) Pub. No.: US 2007/0110030 A1
(43) Pub. Date: May 17, 2007

(54) Wireless Bluetooth internet phone

(76) Inventor: Chia-Chun Wu, Taipei City (TW)

Correspondence Address: Connolly Bove Lodge & Hutz, LLP, P.O. Box 2207, Wilmington, DE, 19899-2207, US

(21) Appl. No.: 11/273,177

(22) Filed: Nov. 14, 2005

(51) Int. Cl. H04L 12/66

(52) U.S. Cl. 370/352

(57) ABSTRACT

Disclosed is a wireless Bluetooth internet phone. The wireless internet phone comprises a central processing unit, a wireless communicating interface, a voice control interface, an operating interface, and a display control interface. The central processing unit is coupled to the wireless communicating interface to establish a bidirectional wireless signal link with a computer by Bluetooth and automatic frequency hopping. The central processing unit is further coupled to the voice control interface to execute input/output of bidirectional voice signal. The operating interface is to control function operations of the internet phone. The display control interface is to control and display a usage condition and battery condition of the internet phone.

### BACKGROUND OF THE INVENTION

1. Field of the Invention

The present invention relates to a wireless Bluetooth internet phone, and more particularly to an internet phone applying to a computer by a wireless Bluetooth and an automatic frequency hopping.

2. Description of the Prior Art

In the conventional arts, the phone communication employs wire or wireless communication link to execute voice communications between an originator and a recipient. This is a generally used and fast signal communication technology. However, the communication technology in practice has to establish communication link by extra putting up phone cables and processing signal through phone exchanges. Namely, based on the recent technology, the communication link is limited to be linked by phone cables.

In addition, due to the development of electric technology and maturation and generalization of network technology, the signal transmitting by network is not only fast and accurate but also unlimited time and place. Therefore, it has become a general communication method except phone communication for business and person. Recently, the signal communication in the network was only E-mail of non-voice data and signal communication and not immediately word signal and voice communication. Hence, the internet phones have been developed and are available in the market.

The internet phone is a product of voice communication via internet. This technology is to convert voice into digital data, to transmit the data to a phone or computer of receiver via internet, and to convert the digital date into voice. It only needs to pay the broadband network or ISDN fee regardless of the distance between two sides without paying external call charge to communication operator. However, the internet phone needs a complicated installation process and both the communication sides have to be installed in hardware and software before using. It is too difficult to general persons in installation and technology. Furthermore, there are limitations and shortcomings in usage of the internet phone. For example, the conventional internet phone establishes a wire link and a bidirectional signal transmission to a computer via a switching means. Consequently, the user is limited to use internet phone in front of the computer, and so it brings users place limitation and inconvenience.

### SUMMARY OF THE INVENTION

The main objective of the present invention is to provide a wireless Bluetooth internet phone. The wireless Bluetooth internet phone mainly employs an internet phone to make users apply a computer and a network system with Bluetooth and automatic frequency hopping to establish a bidirectional wireless voice communication. Therefore, the elasticity and control thereof is increased and any place within the range of wireless communication can be established the voice communication without the limitation of the front of the computer.

For the objective mentioned above, the present invention provides a wireless Bluetooth internet phone that comprises a central processing unit, a wireless communicating interface, a voice control interface, an operating interface, and a display control interface. The central processing unit is coupled to the wireless communicating interface to establish a bidirectional wireless signal link with a computer by automatic frequency hopping and Bluetooth. The central processing unit is further coupled to the voice control interface to execute input/output of bidirectional voice signal. The operating interface is to control function operations of the internet phone. The display control interface is to display a usage condition and battery condition of the internet phone.

In another preferred embodiment of the present invention, the voice control interface comprises a voice input control interface and a voice output control interface. The voice input control interface controls a microphone means to capture external voice and transmit it to the computer and network system via the central processing unit and the wireless communicating interface. The voice output control interface controls a speaker means to output a voice of the other side transmitted from the network system and the computer.

The operating interface further comprises a set of control buttons to execute phone dialing, phone answering, volume control, and mute in another preferred embodiment.

The display control interface further comprises a display component or an indicating component to display a usage condition and battery condition of the internet phone.

### BRIEF DESCRIPTION OF THE DRAWINGS

FIG. 1 is a block diagram of a preferred embodiment in the present invention; and

FIG. 2 is a block diagram of a voice control interface of a preferred embodiment in the present invention.

### DESCRIPTION OF THE PREFERRED EMBODIMENT

Preferred embodiments of the present invention will disclose the technology of wireless Bluetooth internet phone in the following.

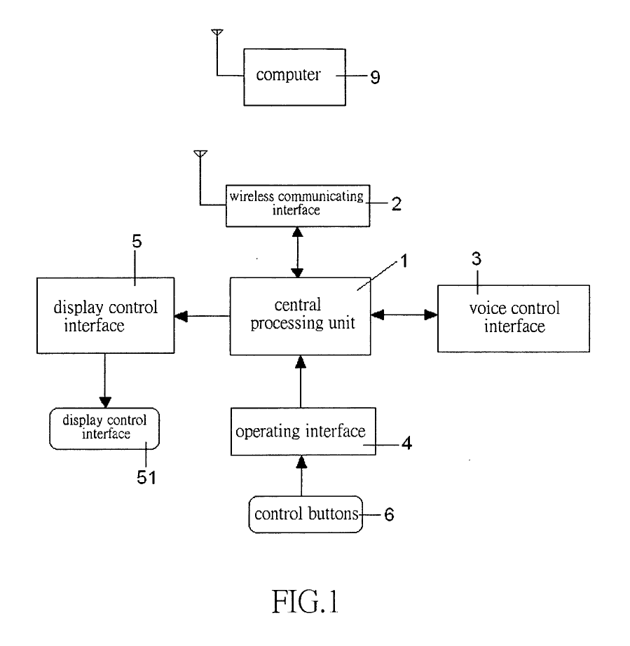

Referring to FIG. 1, it is a block diagram of wireless Bluetooth internet phone of a preferred embodiment in the present invention. The wireless internet phone comprises a central processing unit 1, a wireless communicating interface 2, a voice control interface 3, an operating interface 4, and a display control interface 5. The central processing unit 1 is coupled to the wireless communicating interface 2 for establishing a bidirectional wireless signal link with a computer 9. The voice control interface 3 is coupled to the central processing unit 1 to execute input/output of the bidirectional voice signal between a transmitter and a receiver. The operating interface 4 is to control function operations of the internet phone. The display control interface 5 is to control and display a usage condition and battery condition of the internet phone.

The central processing unit 1 mentioned above could be a microprocessor, CPU, or MPU in the embodiment. The central processing unit 1 executes and controls the signal transmitting and receiving processes of the wireless communicating interface 2. The captured voice is transmitted to the voice control interface 3 via the central processing unit 1 for executing the voice output of the transmitter. The voice control interface 3 also converts the voice from the transmitter into a signal adapted to Bluetooth transmission technology, and transmits it to the computer 9 via the wireless communicating interface 2. In addition, the central processing unit 1 is coupled to the operating interface 4 and executes various function operation instructions there from. The central processing unit 1 controls the display control interface 5 to display the recent usage condition of the internet phone.

The wireless communicating interface 2 is coupled to input/output ports of the central processing unit 1. In the embodiment, the wireless communicating interface 2 is a wireless input/output interface, and preferably wireless Bluetooth interface to establish a bidirectional wireless signal link and communication with Bluetooth and automatic frequency hopping.

In the embodiment, the wireless Bluetooth interface employs 2.4 GHz with automatic frequency hopping of 1 MHz channel space and 1600 hops/sec among 93 channels. The wireless Bluetooth interface is set to automatically establish wireless signal link to the computer 9 with frequency hopping.

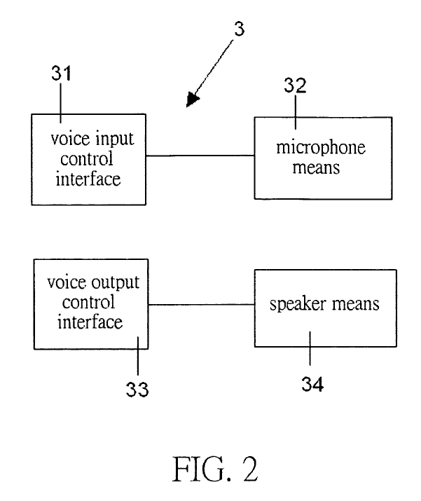

The voice control interface 3 is coupled to the central processing unit 1. The voice control interface 3 mainly executes the bidirectional voice signal input/output control between the transmitter and the receiver, and executes signal transmitting and receiving with the central processing unit 1. In the embodiment, the voice control interface 3, as shown in FIG. 2, comprises a voice input control interface 31 and a voice output control interface 33. The voice input control interface 31 controls a microphone means 32 to capture external voice and transmits it to the computer 9 and the network system via the central processing unit 1 and the wireless communicating interface 2. The voice output control interface 33 controls a speaker means 34 to sound the voice of the other side transmitted from the computer 9 and the network system and via the central processing unit 1 and the wireless communicating interface 2.

The operating interface 4 is coupled to the central processing unit 1 to input the instructions of function operation thereto. In the embodiment, the operating interface 4 is further coupled to a set of control buttons 6 comprising buttons of phone dialing, phone answering, volume control, and mute. Therefore, the user can easy control the internet phone and the control signal is transmitted to the central processing unit 1 for executing.

The display control interface 5 is coupled to the central processing unit 1 and displays usage condition and battery condition of the internet phone according to an indicating control signal of the central processing unit 1. In a preferred embodiment, the display control interface 5 further connects with a display unit 51, such as an LCD, an LCM, an indicating unit, or plural LED lights, to display the usage condition of the internet phone, such as use, stand-by, call hold, call waiting, battery bar, low battery warning, and so on.

In the present invention, all components of the central processing unit 1, the wireless communicating interface 2, the voice control interface 3, the operating interface 4, the display control interface 5, the microphone means 32, the speaker means 34, the set of control buttons 6, and the display unit 51 can be integrated into a telephone. The user can hold it in any place within the range of wireless communication to establish wireless signal link with the computer 9 by automatic frequency hopping for dialing internet phone or taking a call.

The phone user uses the control buttons 6 of the operating interface 4 to make a dial operation to the other side, and the central processing unit 1 processes the signal to be adapted to Bluetooth transmission technology and transmits it to the computer 9 through the wireless communicating interface 2. The computer 9 establishes communication link with the other side and the respective voices is transmitted and received via the computer 9 and the wireless communicating interface 2, converted by the central processing unit 1, and input/output by the microphone means 32 and speaker means 34 of the voice control interface 3 for achieving a bidirectional wireless Bluetooth communication of transmitter and receiver. In addition, the phone user can take a call through the control buttons 6 of the operating interface 4. The usage condition, battery bar, or low battery of the internet phone is displayed by the display control interface 5 controlled by the central processing unit 1.

Although specific embodiments have been illustrated and described, it will be obvious to those skilled in the art that various modifications may be made without departing from what is intended to be limited solely by the appended claims.

What is claimed is:

1. A wireless Bluetooth internet phone for connecting with a computer to establish a wireless communication link, comprising:
an internet phone;
a central processing unit assembled in said internet phone;
a wireless communicating interface coupled to said central processing unit, establishing a wireless signal link with said computer;
a voice control interface coupled to said central processing unit, controlling voice input/output;
an operating interface coupled to said central processing unit, controlling function operations of said internet phone; and
a display control interface coupled to said central processing unit, displaying a usage condition and warning of said internet phone.

2. The wireless Bluetooth internet phone according to claim 1, wherein said wireless communicating interface is a wireless signal input/output interface with a Bluetooth.

3. The wireless Bluetooth internet phone according to claim 1, wherein said wireless communicating interface is to establish a bidirectional wireless signal link with said computer by Bluetooth and automatic frequency hopping.

4. The wireless Bluetooth internet phone according to claim 1, wherein said voice control interface comprises a voice input control interface to capture external voice, and a voice output control interface to control a voice output transmitted from said central processing unit.

5. The wireless Bluetooth internet phone according to claim 4, wherein said voice control interface further comprises a microphone means controlled by said voice input control interface to capture external voice.

6. The wireless Bluetooth internet phone according to claim 4, wherein said voice control interface further comprises a speaker means controlled by said voice output control interface to control a voice output transmitted from said central processing unit.

7. The wireless Bluetooth internet phone according to claim 1, wherein said operating interface comprises a set of control buttons to execute phone dialing, phone answering, volume control, and mute.

8. The wireless Bluetooth internet phone according to claim 1, wherein said display control interface further connects with a display unit controlled to display usage condition and battery condition of said internet phone.

9. The wireless Bluetooth internet phone according to claim 8, wherein said display unit is a display component or an indicating component.

10. The wireless Bluetooth internet phone according to claim 9, wherein said display component is an LCD, or an LCM.

11. The wireless Bluetooth internet phone according to claim 9, wherein said indicating component is plural LED lights.

12. The wireless Bluetooth internet phone according to claim 1, wherein said internet phone is a telephone.

13. A wireless Bluetooth internet phone having a computer and an internet phone connecting with said computer to establish a wireless communication link, comprising:
a central processing unit;
a wireless communicating interface coupled to said central processing unit, establishing a wireless signal link with said computer;
a voice control interface coupled to said central processing unit, controlling voice input/output;
an operating interface coupled to said central processing unit, controlling function operations of said internet phone; and
a display control interface coupled to said central processing unit, displaying a usage condition and warning of said internet phone.
